(19) United States
(12) Patent Application Publication
(10) Pub. No.: US 2025/0224353 A1
(43) Pub. Date: Jul. 10, 2025

(54) HYDRAULIC SYSTEM CAVITATION DETECTION SYSTEM AND METHOD BASED ON THERMOCOUPLE MODULE

(71) Applicant: SHANDONG UNIVERSITY OF SCIENCE AND TECHNOLOGY, Qingdao (CN)

(72) Inventors: Qiang ZHANG, Qingdao (CN); Runxin ZHANG, Qingdao (CN); Wei LIU, Qingdao (CN); Chunyong FAN, Qingdao (CN); Hengxuan LUAN, Qingdao (CN); Feng ZHOU, Qingdao (CN); Hong ZHANG, Qingdao (CN); Ying TIAN, Qingdao (CN); Yunjie PENG, Qingdao (CN); Lingcheng KONG, Qingdao (CN); Jinpeng SU, Qingdao (CN)

(21) Appl. No.: 19/019,740

(22) Filed: Jan. 14, 2025

Related U.S. Application Data
(63) Continuation of application No. PCT/CN2024/078304, filed on Feb. 23, 2024.

(30) Foreign Application Priority Data
Jan. 9, 2024 (CN) 202410028918.0

(51) Int. Cl. G01N 25/08; F17D 5/00

(52) U.S. Cl. CPC G01N 25/08; F17D 5/00

(57) ABSTRACT

A hydraulic system cavitation detection system and a method based on thermocouple module are provided. The hydraulic system cavitation detection system includes a cavitation adjusting device arranged at one side of a hydraulic pipeline to be detected; a first thermocouple module arranged on the cavitation adjusting device; a second thermocouple module arranged on the hydraulic pipeline to be detected; and a detection control center electrically connected with the first thermocouple module and the second thermocouple module respectively. The cavitation detection method is executed by the hydraulic system cavitation detection system.

### CROSS-REFERENCE TO RELATED APPLICATIONS

This application is a continuation of PCT/CN2024/078304, filed on Feb. 23, 2024, and claims priority of Chinese Patent Application No. 202410028918. 0, filed on Jan. 9, 2024, the entire contents of which are incorporated herein by reference.

### TECHNICAL FIELD

The present application belongs to the technical field of hydraulic cavitation detection, and in particular to a hydraulic system cavitation detection system and a method based on thermocouple module.

### BACKGROUND

Cavitation refers to the phenomenon that in liquid, the pressure in a certain basin is lower than the saturated vapor pressure at this temperature, and the air dissolved in the liquid is separated and vaporized, thus generating bubbles. The instantaneous bursting of bubbles will release a lot of heat and damage the hydraulic components.

The thermocouple sensor is a contact temperature-measuring device which has a simple structure and is convenient to use, so it is widely used in industrial production. Thermocouple can directly convert thermal energy into electrical signals and output direct current voltage signals, which makes display, recording and transmission easy. Thermocouple has the characteristics of stable performance, wide temperature measuring range and long-distance signal transmission.

Based on above, it is possible to detect the cavitation phenomenon of hydraulic system by relying on thermocouple module and making full use of the physical characteristics of cavitation rupture to release a lot of heat.

### SUMMARY

Therefore, the application provides a hydraulic system cavitation detection system and a method based on thermocouple module, aiming at improving the real-time and accuracy of cavitation detection of the hydraulic system.

In order to achieve the above objective, in one aspect, the present application provides a hydraulic system cavitation detection system based on thermocouple module, including:
a cavitation adjusting device, arranged at one side of a hydraulic pipeline to be detected and used for simulating the cavitation phenomenon of the pipeline;
a first thermocouple module, arranged on the cavitation adjusting device;
a second thermocouple module, arranged on the hydraulic pipeline to be detected; and
a detection control center, electrically connected with the first thermocouple module and the second thermocouple module respectively and used for detecting the current generated by the temperature difference between the first thermocouple module and the second thermocouple module.

Optionally, the cavitation adjusting device includes:
a water tank;
a water suction pipe, connected with the water tank;
a return pipe, connected with the water tank; and
a circulating water pump, connected with the water suction pipe and the return pipe; and
a gas generating device located on the return pipe for generating cavitation gas in the return pipe.

Optionally, the gas generating device includes a venturi tube located on the return pipe and a ventilation motor located at the water inlet side of the venturi tube.

Optionally, the first thermocouple module is located at the water outlet side of the venturi tube.

Optionally, the return pipe is parallel to the hydraulic pipeline to be detected and has the same diameter as the hydraulic pipeline to be detected.

According to above technical scheme, the application provides a hydraulic system cavitation detection system based on thermocouple module, and the degree of cavitation in the hydraulic system can be judged by comparing the current of the first thermocouple module in the cavitation adjusting device with that of the second thermocouple module of the hydraulic pipeline to be detected.

On the other hand, the application also provides a hydraulic system cavitation detection method based on thermocouple module, which is executed by the hydraulic system cavitation detection system based on the thermocouple module, and the hydraulic system cavitation method includes the following steps:
S1, connecting the first thermocouple module on a cavitation adjusting device to the detection control center;
S2, connecting the second thermocouple module on the hydraulic pipeline to be detected to the detection control center;
S3, starting the cavitation adjusting device;
S4, monitoring the current of the second thermocouple module through the detection control center;
S5, adjusting the cavitation degree of the cavitation adjusting device until the current of the second thermocouple module fluctuates; and
S6, recording the cavitation degree value displayed by the cavitation adjusting device at this time.

The application has following beneficial effects.

The application provides a hydraulic system cavitation detection system and a method based on thermocouple module, which realizes the real-time monitoring of the cavitation phenomenon of the hydraulic system, and can simultaneously convert the cavitation phenomenon into visual data, and convert the heat released by bubble rupture in the hydraulic system into an electrical signal through the thermocouple modules and transmit the electrical signal to the detection control center, thus greatly improving the real-time and accuracy of the detection of cavitation phenomenon of the hydraulic system. Since the current of thermocouple modules changes with the change of temperature, a detection system is built to artificially create the cavitation degree, monitor the current in first thermocouple, and analyze the cavitation degree of hydraulic system by comparing the current in second thermocouple and in first thermocouple.

### BRIEF DESCRIPTION OF THE DRAWINGS

In order to explain the embodiments of the present application or the technical scheme in the prior art more clearly, the figures in the embodiments will be briefly introduced below. Obviously, the figures below describe only some embodiments of the present application, and other drawings can be obtained according to these figures without creative work for ordinary people in the field.

FIG. 1 is a schematic structural diagram of a hydraulic system cavitation detection system based on thermocouple module in Embodiment 1 according to present application.

FIG. 2 is a diagram showing the positional relationship between the cavitation detection system and the control system in Embodiment 1 according to present application.

FIG. 3 is a schematic structural diagram of the cavitation adjusting device in Embodiment 1 of according to the present application.

FIG. 4 is a flowchart of a hydraulic system cavitation detection method based on thermocouple module in Embodiment 2 according to present application.

### DETAILED DESCRIPTION OF THE EMBODIMENTS

In the following, the technical scheme in the embodiments of the application will be clearly and completely described with reference to the attached figures. Obviously, the described embodiments are only a part of the embodiments of the application, but not the all embodiments. Based on the embodiments in the present application, all other embodiments obtained by ordinary technicians in the field without creative labor belong to the scope of protection of the present application.

In order to make the above objectives, features and advantages of the present application more obvious and easier to understand, the present application will be further described in detail with the attached figures and specific embodiments.

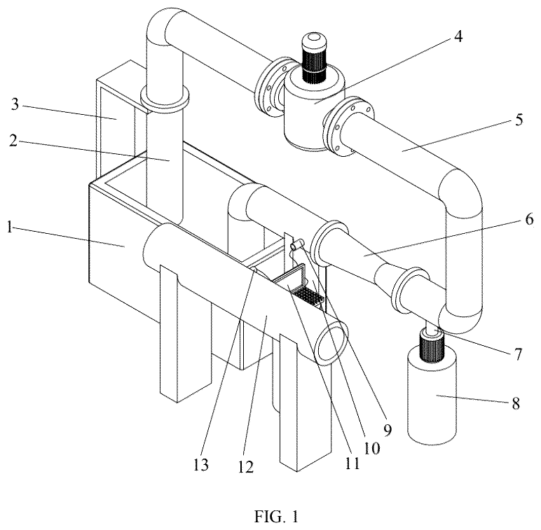

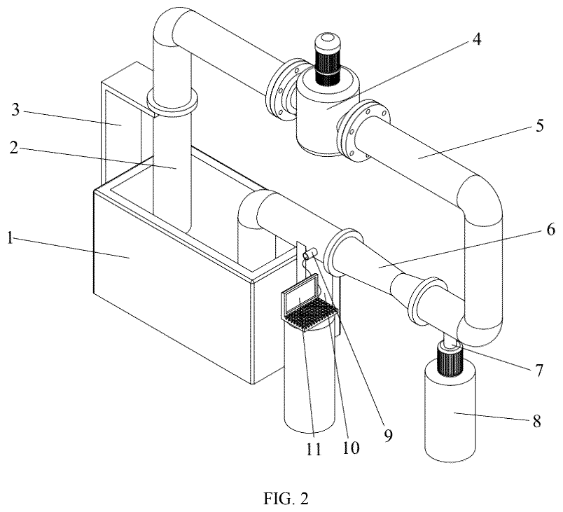

Hereinafter, a hydraulic system cavitation detection system and method based on thermocouple module of the present application will be described with reference to FIG. 1 to FIG. 4.

### Embodiment 1

Referring to FIG. 1, FIG. 1 shows a structural schematic diagram of a hydraulic system cavitation detection system based on thermocouple module provided by the present application, which includes a cavitation adjusting device arranged at one side of a hydraulic pipeline 12 to be detected. The cavitation adjusting device is provided with a first thermocouple module 9, and corresponding to the first thermocouple module 9, the hydraulic pipeline 12 to be detected is provided with a second thermocouple module 13 opposite to the first thermocouple module 9. The hydraulic system cavitation detection system also includes a detection control center 11 located between the first thermocouple module 9 and the second thermocouple module 13. The detection control center 11 is used to detect the current generated by the temperature difference between the first thermocouple module 9 and the second thermocouple module 13, realize the cavitation detection of the hydraulic pipeline 12 to be detected, and then judge whether the hydraulic system including the hydraulic pipeline 12 to be detected has cavitation phenomenon and the degree of cavitation.

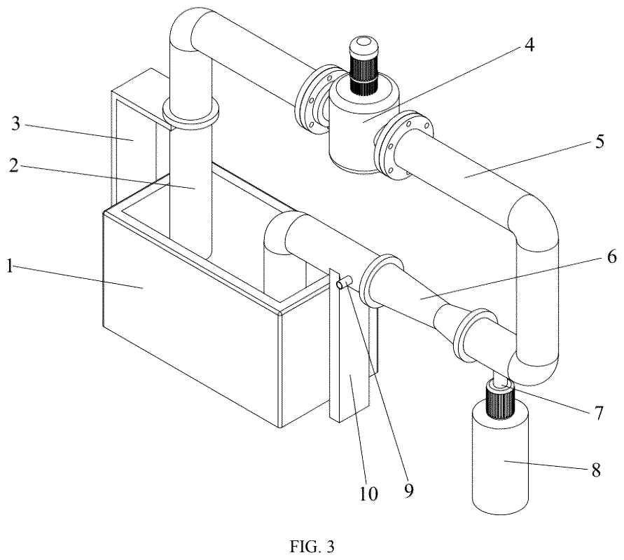

Specifically, as shown in FIG. 3, the cavitation adjusting device includes a water tank 1, a water suction pipe 2, a pipeline supporting frame 3, a circulating water pump 4, a return pipe 5, a venturi tube 6, a ventilation motor 7, a supporting table 8, a first thermocouple module 9 and a return supporting frame 10. Among them, the water suction pipe 2, the circulating water pump 4 and the return pipe 5 constitute a water circulation pipeline which is circularly connected with the water tank 1. One end of the water suction pipe 2 extends into the water tank 1 and the other end of the water suction pipe 2 is connected with the circulating water pump 4. The circulating water pump 4 is connected with the return pipe 5, and the backwater end of the return pipe 5 extends into the water tank 1. The water suction pipe 2 and the return pipe 5 form a pipeline connection, both ends of the pipeline are communicated with the water tank 1, and the pipeline is provided with the circulating water pump 4. More specifically, the water suction pipe 2 is fixed by the pipeline supporting frame 3, and the return pipe 5 is supported by the return supporting frame 10. Further, a segment of venturi tube 6 is arranged on the return pipe 5 for generating cavitation bubbles, and a ventilation motor 7 is connected to the return pipe 5 on the water inlet side of the venturi tube 6. The ventilation motor 7 is supported and fixed under the return pipe 5 through a supporting table 8, and ventilation end of the ventilation motor 7 is connected to the return pipe 5, so as to provide gas to return pipe to artificially create cavitation, and the ventilation amount can be controlled by adjusting the ventilation motor 7. One side wall of the return pipe 5 on the water outlet side of the venturi tube 6 is provided with the first thermocouple module 9 facing the hydraulic system. The hydraulic system includes a hydraulic pipeline 12 to be detected arranged in parallel with the return pipe 5, and a second thermocouple module 13 matched with the first thermocouple module 9 is arranged on the hydraulic pipeline 12 to be detected.

Further, the water suction pipe 2 is connected to the circulating water pump 4 by bolt connection, the pipeline supporting frame 3 is connected to the water suction pipe 2 by bolt connection, one end of the circulating water pump 4 is connected to the water suction pipe 2 and the other end of the circulating water pump 4 is connected to the return pipe 5 by bolt connection, the venturi tube 6 is installed in the middle of the return pipe 5 by bolt connection, and the ventilation motor 7 is installed between the venturi tube 6 and the circulating water pump 4 and is adjacent to the venturi tube 6. The supporting table 8 is used to support the ventilation motor 7, and the first thermocouple module 9 is used in cooperation with the second thermocouple module 13. The first thermocouple module 9 is installed behind the venturi tube 6 and in the return pipe 5 to detect the heat released by the bubble rupture in the cavitation detection system, and the second thermocouple module 13 is used to detect the temperature in the hydraulic pipeline 12 to be detected. The return supporting frame 10 is used to support the return pipe 5, and the detection control center 11 detects the current generated by the temperature difference between the first thermocouple module 9 and the second thermocouple module 13.

The working principle of Embodiment 1 of the present application is that the water tank 1 provides circulating water for the cavitation adjusting device, and the water flows from the water suction pipe 2 to the circulating water pump 4, and the water flows from the return pipe 5 to the venturi tube 6 and has cavitation under action of the venturi tube 6, and the water flows back to the water tank 1 through the return pipe 5. At the same time, the ventilation motor 7 can adjust the ventilation amount, thus providing gas for the return pipe 5, artificially creating cavitation. The bursting of air bubbles in return pipe 5 will release a lot of heat, and the existence of heat makes the first thermocouple module 9 heat, which will lead to a temperature difference between two thermocouple modules, thus generating current.

### Embodiment 2

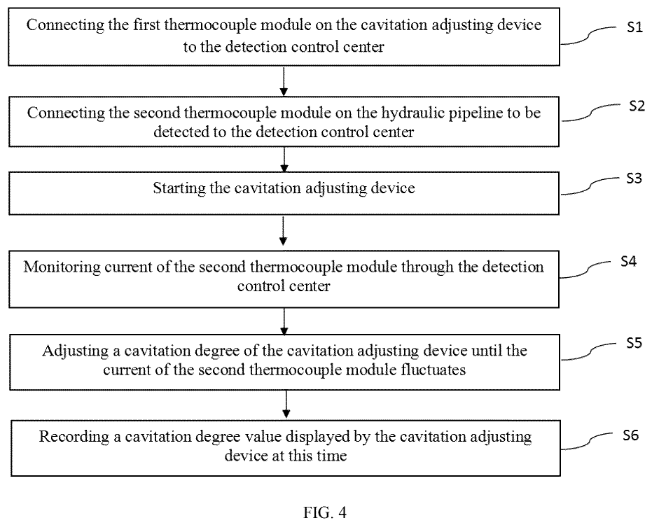

Referring to FIG. 4, FIG. 4 shows the flow chart of the hydraulic system cavitation detection method based on the thermocouple module provided by the present application, which includes the following steps:
S1, selecting a cavitation adjusting device including a return pipe 5 parallel to the hydraulic pipeline 12 to be detected and having the same diameter as the hydraulic pipeline 12 to be detected, and installing a first thermocouple module 9 on the return pipe 5; connecting the first thermocouple module 9 to the detection control center 11;
S2, installing a second thermocouple module 13 on the hydraulic pipeline 12 to be detected; connecting the second thermocouple module 13 to the detection control center 11;
S3, pumping circulating water into the return pipe 5, and turning on a gas generating device;
S4, monitoring the current of the second thermocouple module 13 through the detection control center 11;
S5, adjusting the bubble generation amount of the gas generating device until the current of the second thermocouple module 13 fluctuates; and
S6, recording the bubble generation amount of the gas generating device at this time as the cavitation degree value of the hydraulic pipeline 12 to be detected.

The cavitation monitoring system established by the application exists as a contrast, and the system will always have cavitation phenomenon, and at the same time, the degree of cavitation can be adjusted artificially. However, there is no cavitation in the hydraulic system during normal operation, and there will be no bubble rupture to release a lot of heat. Therefore, the detected current of the second thermocouple module is very low. As the hydraulic system gradually have cavitation, bubbles are generated in the system. With the bursting of bubbles, a lot of heat is released, and the current in second thermocouple increases and fluctuates. In this way, the cavitation in the hydraulic system can be judged. At the same time, the degree of cavitation in the hydraulic system can be judged by comparing with the current in second thermocouple in the cavitation detection system established by the application.

The application has following advantages.

The basic principle of thermocouple temperature measurement is that two kinds of material conductors with different compositions form a closed loop, and when there is a temperature gradient at both ends, current will flow in the loop, and at this time, there is electromotive force/thermoelectromotive force between the two ends, which is the so-called Seebeck effect. Due to the bursting of cavitation bubbles, a large amount of heat will be released. Relying on this physical characteristic, the thermocouple modules will generate current due to the temperature difference between the two ends. By detecting the current of second thermocouple module in the hydraulic pipeline of the hydraulic system and comparing it with the current of the first thermocouple module in return pipe in the detection system, whether the hydraulic system has cavitation phenomenon and the degree of cavitation can be judged.

Any aspects not detailed in the present application are conventional technical means known to those skilled in the art.

In the description of the present application, it should be understood that the terms “longitudinal”, “transverse”, “up”, “down”, “front”, “back”, “left”, “right”, “vertical”, “horizontal”, “top”, “bottom”, “inside”, “outside” and other directional or positional relationships indicated are based on the directional or positional relationships shown in the accompanying drawings, only for the convenience of describing the present application, and do not indicate or imply that the device or element referred to must have a specific orientation, be constructed and operated in a specific orientation, and therefore cannot be understood as a limitation of the present application.

The above-mentioned embodiments only describe the preferred mode of the application, and do not limit the scope of the application. Under the premise of not departing from the design spirit of the application, various modifications and improvements made by ordinary technicians in the field to the technical scheme of the application shall fall within the protection scope determined by the claims of the application.

What is claimed is:

1. A hydraulic system cavitation detection system based on thermocouple module, comprising:
a cavitation adjusting device, arranged at one side of a hydraulic pipeline to be detected and used for simulating cavitation phenomenon of the hydraulic pipeline;
a first thermocouple module, arranged on the cavitation adjusting device;
a second thermocouple module, arranged on the hydraulic pipeline to be detected; and
a detection control center, electrically connected with the first thermocouple module and the second thermocouple module respectively and used for detecting current generated by a temperature difference between the first thermocouple module and the second thermocouple module.

2. The hydraulic system cavitation detection system based on thermocouple module according to claim 1, wherein the cavitation adjusting device comprises:
a water tank;
a water suction pipe, connected with the water tank;
a return pipe, connected with the water tank;
a circulating water pump, connected with the water suction pipe and the return pipe; and
a gas generating device located on the return pipe for generating cavitation gas in the return pipe.

3. The hydraulic system cavitation detection system based on thermocouple module according to claim 2, wherein the gas generating device comprises a venturi tube located on the return pipe and a ventilation motor located at a water inlet side of the venturi tube.

4. The hydraulic system cavitation detection system based on thermocouple module according to claim 3, wherein the first thermocouple module is located at a water outlet side of the venturi tube.

5. The hydraulic system cavitation detection system based on thermocouple module according to claim 2, wherein the return pipe is parallel to the hydraulic pipeline to be detected and has a same diameter as the hydraulic pipeline to be detected.

6. A hydraulic system cavitation detection method based on thermocouple module, executed by the hydraulic system cavitation detection system based on thermocouple module according to claim 1, comprising following steps:
S1, connecting the first thermocouple module on the cavitation adjusting device to the detection control center;
S2, connecting the second thermocouple module on the hydraulic pipeline to be detected to the detection control center;
S3, starting the cavitation adjusting device;
S4, monitoring current of the second thermocouple module through the detection control center;
S5, adjusting a cavitation degree of the cavitation adjusting device until the current of the second thermocouple module fluctuates; and
S6, recording a cavitation degree value displayed by the cavitation adjusting device at this time.
